(19) United States
(12) Patent Application Publication
(10) Pub. No.: US 2014/0278633 A1
(43) Pub. Date: Sep. 18, 2014

(54) SKILL-BASED CANDIDATE MATCHING

(71) Applicants: Kevin M. Daly, Balboa, CA (US); Jean M. Aycock, Palm Bay, FL (US); Michael D. Cook, San Clemente, CA (US)

(72) Inventors: Kevin M. Daly, Balboa, CA (US); Jean M. Aycock, Palm Bay, FL (US); Michael D. Cook, San Clemente, CA (US)

(21) Appl. No.: 13/796,041

(22) Filed: Mar. 12, 2013

(51) Int. Cl. G06Q 10/06

(52) U.S. Cl. CPC G06Q 10/063112; G06Q 10/1053
USPC 705/7.14

(57) ABSTRACT

Systems and methods are provided for enabling skill-based searching for jobs and/or job candidates. A number of profiles, resumes and/or other data records may be stored in association with a number of individuals, where each record may include information regarding skills and associated skill competency levels possessed by an individual. The records may be searched based on various criteria, such as by indicating a skill and associated minimum competency level desired of candidates.

### BACKGROUND

Recruiters and companies seeking individuals for a job opening often search for and/or browse a number of different websites or other Internet services in search of potential candidates. Currently, various job boards, job aggregators and professional networks each provide some level of search capability for employers and recruiters to locate talent and/or for job seekers to search for job openings. However, many of these existing systems provide only limited search capabilities, such as only providing basic keyword searching of resumes or user profiles. Furthermore, candidate matches (which may be provided to a recruiter) and job listing matches (which may be provided to a job seeker) provided in response to searches submitted in existing systems are typically presented without any indication of whether the results are perfect matches, close matches, or merely partial matches. For example, some existing candidate search systems provide a list of potential candidates who have uploaded resumes that may include a few of the searcher's submitted keywords. A recruiter or other person searching for candidates may then browse profiles or resumes associated with each potential candidate included in the search results in order to manually determine whether the recruiter is interested in the given potential candidate.

### BRIEF DESCRIPTION OF THE DRAWINGS

Specific embodiments of a system and associated processes for skill-based searching and other aspects of the present disclosure will now be described with reference to the accompanying drawings, wherein:

FIG. 1 is a block diagram depicting an illustrative operating environment in which a user computing device may send search requests and other information to a skill management system and/or other related systems, and in which the skill management system may generate skill entries and/or determine search results for skill-based searches.

FIG. 2 illustrates data flows between the skill management system and other related systems depicted in an illustrative operating environment.

FIG. 3 depicts a general architecture of a skill management system for creating and managing skill entries, and for determining matches for skill-based searches.

FIG. 4 is an illustrative user interface generated by the skill management system for display on a user's computing device that includes skill information associated with an individual.

FIG. 5 is an illustrative user interface generated by the skill management system that enables a user to edit information associated with the user's resume, including options for entering skill information.

FIG. 6 is a flow diagram of an illustrative method implemented by the skill management system for determining skill information from text data.

FIG. 7 is a flow diagram of an illustrative method implemented by the skill management system for matching one or more candidates to search criteria that includes skill information.

FIG. 8 is an illustrative user interface generated by the skill management system that enables a user to enter candidate search criteria that includes skill information.

FIG. 9 is an illustrative user interface generated by the skill management system that presents candidate matches for skill-based search criteria entered by a user.

### DETAILED DESCRIPTION OF SPECIFIC EMBODIMENTS

Aspects of the present disclosure relate to providing recruiters and other individuals with information regarding job candidates that match specific skill-based criteria provided by the recruiter and/or determined from a job listing, and for enabling the user to establish a connection or electronic communication with one or more candidate matches. Aspects of the present disclosure also enable job seekers to search for job openings that match the user's specific skills and skill competency levels. As mentioned above, existing candidate search systems typically provide a recruiter or other individual searching for job candidates with a list of potential candidates who have uploaded resumes that may include one or more of a searcher's submitted keywords. Traditional employment candidate search systems, for example, do not provide a recruiter with the ability to specify detailed skill information desired of candidates or to specify a relative importance of different skills when submitting candidate search criteria. Furthermore, many traditional job and/or candidate search systems do not provide a meaningful way to evaluate or recognize a candidate's skills and/or the relative competency levels associated with each of a candidate's skills.

According to one embodiment of the present disclosure, a user interface may be presented that enables a recruiter or other user to enter ranked search criteria for a candidate. The recruiter may enter a primary mandatory skill, which may be considered the top ranked criterion. The primary mandatory skill may be a skill that the recruiter requires of a candidate match, such that potential candidates not having the desired skill associated with their profiles and/or resumes will not be presented as a match. The user interface may further enable the recruiter to optionally enter a secondary mandatory skill. In some embodiments, a skill may include a verb and object pairing (such as “programming C++” or “to program C++”) and may be associated with a minimum proficiency or competency level required of candidates, as will be further discussed below. The recruiter may then select a skill category, which may be selected, for example, from a predetermined list of skill categories that are pertinent to the position. The recruiter may additionally enter optional skills desired of candidates, which may be one or more skills that the recruiter or employer would find desirable of a candidate, but which the recruiter does not treat as required skills for a candidate to be considered a match.

A skill search module, as described herein, may determine matching candidate results based on the search criteria received from the recruiter, including ranking the matches based on optional skills and/or other criteria, as will be described in more detail below. In some embodiments, the recruiter may elect one or more options indicating that the skill management system should generate an automatic social network connection (or social employment network connection), interview invitation, or other contact with one or more highest matching candidates. Accordingly, a skill management system described herein, according to certain embodiments, lists not just potential candidates as search results, but identifies prioritized qualified candidates that meet a recruiter's specified ranked skill criteria, and may provide for immediate communication with those candidates via an automatic connection within a social networking service, business networking service, employment networking service, or other service.

FIG. 1 depicts an illustrative operating environment 100 in which user computing devices 104 may send and receive information from one or more of a skill management system 110, skill groups system 132, skill exchange system 136, candidate search system 138, job search system 140, and/or a job broadcast system 142. User computing devices 104 may be operated by, for example, a recruiter, an employer, a human resources manager, a job seeker, an employed individual open to new positions, an individual that wishes to document his skills and establish connections with other users, and/or other individuals. Various interactions between specific systems illustrated in operating environment 100 will be discussed in more detail below with reference to FIG. 2.

The depicted environment 100 includes one or more user computing devices 104, skill management system 110, skill groups system 132, skill exchange system 136, candidate search system 138, job search system 140, and job broadcast system 142 communicatively connected by a network 108, such as the Internet. Those skilled in the art will recognize that the user computing devices 104, skill management system 110, skill groups system 132, skill exchange system 136, candidate search system 138, job search system 140, and/or job broadcast system 142 may collectively be any of a number of computing devices that are capable of communicating over a network including, but not limited to, a computing server, laptop, personal computer, tablet computer, electronic book reader, mobile phone, smart phone, digital music player, and the like. In some embodiments, the skill management system 110 and/or other illustrated systems may include multiple distinct servers or other computing devices, including devices that are geographically distributed and/or are part of a cloud computing service. In some embodiments, one of the skill management system 110, skill groups system 132, skill exchange system 136, candidate search system 138, job search system 140, and job broadcast system 142 may implement aspects of the present disclosure without cooperating or communicating with each other. For example, in some embodiments, a skill management server 110 may be configured to implement functionality that is provided in other embodiments by one or more of the skill groups system 132, skill exchange system 136, candidate search system 138, job search system 140, and/or job broadcast system 142. Accordingly, the skill groups system 132, skill exchange system 136, candidate search system 138, job search system 140, and job broadcast system 142 may not be present in the operating environment of certain embodiments.

In the environment shown in FIG. 1, one or more user computing devices 104 may communicate with the skill management system 110, skill groups system 132, skill exchange system 136, candidate search system 138, job search system 140, and/or job broadcast system 142 via a communication network 108, such as the Internet or other communications link. Communications between the user computing device 104 and the other illustrated systems may be secure, such as by encrypting or encoding the data exchanged. In some embodiments, the user computing devices 104, skill management system 110, skill groups system 132, skill exchange system 136, candidate search system 138, job search system 140, and job broadcast system 142 may include computer hardware and software components similar to those described below with respect to the skill management system 110, and may include modules configured to implement specific functionality of the respective system, as described herein.

As illustrated in FIG. 1, the skill management system 110 includes or communicates with a skill data store 122, a user data store 124 and a job data store 126. The skill data store 122 may include data associated with a number of different skills and skill categories. For example, the skill data store 122 may include a table or list of verbs, and optionally a list of objects of the verbs, which may be used to describe at least one skill of an individual. The skill data store 122 may additionally include a table or list of competency levels that may be associated with various skills. Additional data that may be stored in skill data store 122, in certain embodiments, includes synonym information identifying one or more synonyms for verbs, nouns, or phrases that may be part of a skill or competency level. Those skilled in the art will appreciate that each of the skill data store 122, user data store 124 and job data store 126 may be local to the skill management system 110, may be remote to the skill management system 110, and/or may be a network-based service itself. The user data store 124 may include information associated with a number of users that have registered for an account with the skill management system 110. For example, data stored in user data store 124 may include profile information, resume information and/or skill information associated with a number of individuals, as further described below. In some embodiments, the skill management system 110 may crawl, collect and/or scrape data regarding individuals from various third-party data sources, such as names, email addresses, personal information, professional information and/or other data to be stored in the user data store 124 and/or to be used by the skill management system for various purposes. The job data store 126 may include data associated with a number of job openings, which may include information regarding skills required for the position. In some embodiments, the job data store 126 may also include candidate criteria established by recruiters when searching for candidates with which the recruiter is interested in establishing a connection.

Those skilled in the art will appreciate that the network 108 may be any wired network, wireless network or combination thereof. In addition, the network 108 may be a personal area network, local area network, wide area network, cable network, satellite network, cellular telephone network, etc., or combination thereof. Protocols and components for communicating via the Internet or any of the other aforementioned types of communication networks are well known to those skilled in the art of computer communications and, thus, will not be described in more detail herein.

FIG. 2 illustrates data flows between the skill management system 110 and the skill groups system 132, skill exchange system 136, candidate search system 138, job search system 140, and job broadcast system 142. While not illustrated in FIG. 2, it will be appreciated that one or more user computing devices 104 may provide information to the skill groups system 132, skill exchange system 136, candidate search system 138, job search system 140, and/or job broadcast system 142 which may then be used in the communications between the given system and the skill management system 110. The various systems illustrated in operating environment 200 may be in communication, for example, via a network, such as those described above with reference to network 108. As illustrated in illustrative operating environment 200, the communications between the skill management system 110 and each of the other illustrated systems are not intended to occur in a specific order, but rather illustrate separate processes that may be combined or may occur separately during various users' interactions with the illustrated systems.

As illustrated in FIG. 2, the skill groups system 132 may send information regarding a user and/or skills associated with the user to the skill management system 110. The skill managements system 110 may determine, based on the received data and data stored in the user data store 124 and/or skill data store 122, matching skill groups and/or information regarding users with similar skills as the user associated with the request. For example, a user interacting with the skill groups system 132 may have requested to view a listing of skill groups (which may be, for example, groups of users that have the same skill) associated with one or more of the user's skills. Alternatively, the user may have requested to find other similarly skilled users to communicate with or establish a connection with one or more social networking or other networking services. The skill management system 110 may return the matching skill groups and/or matching users to the skill groups system 132 for display to the requesting user. The skill groups system may then present options for the requesting user to participate in group discussions associated with an identified skill group, initiate private messaging with one or more similarly skilled individuals, and/or other options.

As further illustrated in FIG. 2, the skill exchange system 136, in communication with the skill management system 110, may enable automated assessment of one or more skills possessed by an individual. For example, a user interacting with the skill exchange system 136 may provide information, such as by answering questions and/or other data collection methods, that enables the skill management system 110 to implement an objective assessment of the user's skills and relative proficiency or competency level within each skill. The skill management system 110 may then associate the identified skills and associated competency levels with the user in user data store 124.

In some embodiments, the skill exchange system 136 and/or other systems illustrated in FIG. 2 may communicate with the skill management system 110 in order to provide a job referral option to a user. The referral options may enable a user to refer a job to another member. According to one example, while a user is interacting with the skill exchange system 136, a “refer” option (such as a selectable user interface element) may be presented that can be selected by the user to refer another member for a job. In response to a selection of the refer option, the skill management system 110 may determine if the individual referred for a position is eligible for any jobs stored in job data store 126, such as by the skill-based search methods further described below. For example, the skill management system 110 may retrieve various skill entries and other information included in the referred individual's profile and may compare them to corresponding entries in one or more active job records. If there are active jobs matching the referral criteria, information may be displayed listing the matching job(s). The user may select one or more jobs from the list of eligible jobs, which may then cause the skill management system to generate and send a referral notification to each recruiter or company associated with the selected jobs. In some embodiments, a referring skill may then be added to the user's profile as a result of completing a referral task.

The illustrative operating environment 200 also includes an illustrative data flow between the candidate search system 138 and the skill management system 110. As illustrated, the candidate search system 138 may send information regarding one or more mandatory skills and/or other candidate search criteria to the skill management system. The other search criteria may include, for example, one or more skill categories and/or any optional skills. The criteria may be provided by a recruiter as criteria for which a recruiter would like to find matching individuals with which to establish connections. Alternatively, the provided criteria may be associated with an active job opening. The skill management system may then implement one or more methods to determine matching candidates, such as illustrative method 700, which will be described below. Depending on the embodiment, the skill management system may search individuals' resumes and/or profiles to determine candidate matches. Once the skill management system has determined one or more matching candidates, the skill management system may provide information regarding the qualifying candidates to the candidate search system 138 for further processing and/or for display to the requesting user, as will be further described below.

As further illustrated in FIG. 2, the job search system 140 may communicate with the skill management system 110 in response to a job-seeking user submitting, to the job search system, a search request for job openings or listings that match the user's skills and/or other information regarding the user. As illustrated, the job search system 140 may send filter and/or sorting criteria to the skill management system 110. In some embodiments, a user may submit a search request for active job listings that match the user's skills and competency levels that have been previously associated with the user's profile or resume(s) by the skill management system 110. In other embodiments, the user may be presented with options to select specific skills and/or skill categories for which the user would like to search for matching job listings. When submitting a search for job listings, the job search system may enable the user to indicate any additional filters that should be applied to the search, such as job title, location, distance, company, industry, business area, posting date, job type, education level, and/or other criteria. The user may additionally provide, in some embodiments, data regarding criteria that should be used in sorting the resulting job listings, such as by overall relevance or by selecting one or more of the above-described filter criteria as a sort-by element (either ascending or descending). The skill management system 110 may determine matching job openings, at least in part by applying skill matching similar to that discussed below with reference to illustrative method 700 for implementing a skill match search. The job listings may be active job openings, for example, that were submitted to the skill management system and/or job broadcast system 142 by a recruiter or employer. The skill management system 110 may then provide any matching job records, sorted according to the requested criteria, to the job search system 140 for display to the user and/or for further processing.

In some embodiments, the skill information utilized by the skill management system 110 and/or by one or more of the other systems that are in communication with the skill management system in FIG. 2 may be stored in skill data store 122 based at least in part on collective skill input received from a potentially large number of users. By implementing crowd sourcing techniques, skill input fields presented throughout the illustrated environment of FIG. 2 may be used to obtain skill information for building a true skills database, which may be stored in skill data store 122. For example, the skill management system 110 may employ implicit crowdsourcing, piggyback crowdsourcing and/or other crowdsourcing methods to learn of various skills that should be offered as selectable options to users. In certain embodiments of implicit crowdsourcing implemented by the skill management system 110, users may not necessarily know that they are contributing to building a skill database, but may nevertheless be very effective in providing accurate skill information through their various interactions with the illustrated systems. Rather than users actively participating in solving a problem or providing information, implicit crowdsourcing may involve users doing another task entirely, where a third party gains information for another topic based on the user's actions. In one example, as users enter search information for a job or individual (or perform any other task within a user interface provided by one of the illustrated systems), the skill management system may learn and store information regarding the universe of potential skills that individuals in a given field may possess. As will be appreciated, the skill management system 110 may employ a variety of crowdsourcing techniques that are known in the art in order to provide the most accurate information possible given the collective input received from the systems' users and/or administrators.

FIG. 3 depicts a general architecture of a skill management system 110 for determining skill information and competency levels, determining candidate search matches based on skill information, determining job matches based on a user's skills, and other aspects of the disclosure discussed herein. The skill management system 110 may have one or more processors 302 in communication with a network interface 304, a display interface 306, a computer readable medium drive 308, and an input/output device interface 310, all of which may communicate with one another by way of a communication bus. The network interface 304 may provide connectivity to one or more networks or computing systems. The processor(s) 302 may thus receive information and instructions from other computing systems or services via a network. The processor(s) 302 may also communicate to and from memory 320 and further provide output information or receive input information via the display interface 306 and/or the input/output device interface 310. The input/output device interface 310 may accept input from one or more input devices 324, including, but not limited to, keyboards, mice, trackballs, trackpads, joysticks, input tablets, trackpoints, touch screens, remote controls, game controllers, velocity sensors, voltage or current sensors, motion detectors, or any other input device capable of obtaining a position or magnitude value from a user. The input/output interface 310 may also provide output via one or more output devices 322, including, but not limited to, one or more speakers or any of a variety of digital or analog audio capable output ports. The display interface 306 may be associated with any number of visual or tactile interfaces incorporating any of a number of active or passive display technologies, such as electronic-ink, LCD, LED or OLED, CRT, projection, etc.

The memory 320 contains computer program instructions that the processor(s) 302 execute in order to implement one or more embodiments of the present disclosure. The memory 320 generally includes RAM, ROM and/or other persistent or non-transitory computer-readable media. The memory 320 may store an operating system 314 that provides computer program instructions for use by the processor(s) 302 in the general administration and operation of the computing system 110. The memory 320 may further include other information for implementing aspects of the present disclosure. For example, in one embodiment, the memory 320 includes a user interface module 312 that facilitates generation of user interfaces (such as by providing instructions therefor) for display. For example, a user interface may be displayed via a navigation interface such as a web browser. In addition, memory 320 may include or communicate with an auxiliary data store 340. Data stored in the data store 340 may include data similar to that discussed above with respect to skill data store 122, user data store 124 and/or job data store 126.

In addition to the user interface module 312, the memory 320 may include a skill generator module 112 and a skill search module 114 that may be executed by the processor(s) 302. In one embodiment, the skill generator module 112 may be used to implement various aspects of the present disclosure, such as generating a skill entry based on data received from a user, determining skill information from text data, etc., as described further below. In one embodiment, the skill search module 114 may be used to implement various other aspects of the present disclosure, such as determining job and/or candidate matches based on search criteria or other criteria, as described further below. In certain embodiments of the present disclosure, the skill groups system 132, skill exchange system 136, candidate search system 138, job search system 140, and/or job broadcast system 142 may include several components that operate similarly to the components illustrated as part of the skill management system 110, including a user interface module, processor, computer readable medium drive, etc.

FIG. 4 is an illustrative user interface 400 generated by the skill management system 110 for display on a user's computing device 104 that includes skill information associated with a user. The illustrative user interface 400 may be considered a profile interface and may be displayed, for example, by a browser executed by the user's computing device 104. As illustrated, the user may be Joe Smith, an individual that has previously established an account with the skill management system 110. Alternatively, the user could be someone other than Joe Smith that has selected to view Joe Smith's profile information, such as an employer or recruiter. The illustrated profile interface 400 includes skill information 402, which may have been generated by the skill management system 110 based on skill data retrieved from user data store 124 and/or skill data store 122. In the illustrated embodiment, each skill entry identified in the profile interface includes a skill, comprising a verb and an object of the verb (typically a noun), and an indication of a competency level associated with the verb and object combination. For example, the first illustrated skill indicates that Joe Smith “administers Apache servers at an apprentice level of competency.” In some embodiments, the entire string of text may be stored in skill data store 122 as a skill entry associated with the user. In other embodiments, a stored skill entry for the illustrated skill in skill data store 122 may be a verb entry of “administer,” an object entry of “Apache servers” and a competency entry of “apprentice.” It will be appreciated that, in other embodiments, a skill entry may include a phrase without a verb, such as “Apache server administration,” a verb and an adverb, or any other grammatical combination.

As illustrated, profile interface 400 also includes work experience information associated with the identified user, Joe Smith. The work experience information includes, for example, an entry 404 indicating that Joe Smith previously worked as an information technology consultant. Skill entry 404 includes information associated with Joe Smith's position as an information technology consultant, including job title, industry, business areas, skill categories and skills with associated competencies. The listed skill categories include “Data Warehousing” at a novice level of competency, and “IT Project Management” at a beginner level of competency. The listed skill competencies include an indication that while employed as an information technology consultant, Joe Smith performed process mapping at a supervisory level of competency. Accordingly, user interface 400 includes both skills and associated competency levels currently possessed by the individual, as well as skill and associated competency levels that the user had attained during each of a number of previous jobs. In embodiments other than that illustrated in FIG. 4, there may be competency levels associated with skills, but not with skill categories.

While not illustrated in FIG. 4, in some embodiments, a profile interface may additionally include information regarding the years of experience that a user has for each skill and/or a length of time that the individual has been at each skill competency level within a skill. For example, in one embodiment, a profile interface generated by the skill management system 110 may indicate that a given user had six months of experience at a beginner level of competency in a given skill (perhaps split across multiple jobs) and has now been at an intermediate level of competency in the same skill for eight months (in the same job and/or in a new job), for a cumulative total of fourteen months of experience with respect to the given skill. In some embodiments, the above time and skill information may be determined and stored by a skill inventory module or skill inventory subsystem of the skill management system 110.

FIG. 5 is an illustrative user interface 500 generated by the skill management system 110 that enables a user to edit information associated with the user's resume, including options for entering skill information. The user interface 500 includes an option for the user to enter a name 502 for the resume and a description 504 for the resume. The user may also select a business area 506 and skill category 508 associated with the resume. In the illustrated embodiment, the business area 506 and skill category 508 may be selected from a list of predetermined eligible selections stored in skill data store 122. The available selection options for skill category and/or business area, in some embodiments, may be based on industry standard terms and/or terms recognized by a governmental labor department or organization.

Illustrative interface 500 includes options for entering a primary skill and a secondary skill associated with the given resume. In some embodiments, the options 512, 514 and 516 may collectively be considered skill entry generation options that are used by the skill generator module 112 to generate a skill entry to associate with the user and/or with a resume of the user. In other embodiments, the skill generator module 112 may automatically determine a skill and/or skill competency level from free-form text, narrative text, and/or text imported from a resume (discussed in more detail below), without necessarily presenting the user with options similar to options 512, 514 and 516. As illustrated, the user may select a verb from a selectable list of verbs 512. The verbs available to be selected may include, for example, verbs associated with selected skill category 508 in skill data store 122. In other embodiments, the verb options may include all verbs in the English language, or all verbs that have been associated with at least one skill entry in skill data store 122. The user may enter a noun, an adjective and noun, a phrase or other object of the verb in field 514. As illustrated in user interface 500, the user has entered “PHP,” a computer programming language, in field 514. In some embodiments, once the user has entered a term in field 514, the list of available verb options 512 and/or proficiency level options 516 may be dynamically adjusted by the skill management system 110 to only include verbs and/or proficiency levels that are compatible with the entered term. For example, the selectable verb options 512 may be narrowed to include only verbs that have been associated with “PHP” in at least one skill entry stored in skill data store 122, such as “code,” “program,” “debug,” etc. In some embodiments, the skill management system may filter user input or parsed text across some or all portions of the system to screen or prevent entry of prohibited words or phrases, as stored in a data store, in order to eliminate or prohibit expletives and/or offensive language.

As illustrated, the competency level or proficiency level that the user has attained for the “code PHP” skill may be selected by the user from option 516. In some embodiments, the available options from which the user may select a competency level may be the same regardless of specific skill entered (for example, selecting from beginner, intermediate, or expert). In other embodiments, the available options may be based on the business area, the skill category, and/or the specific verb and noun entered in options 512 and 514. While the embodiment illustrated in FIG. 5 includes competency level options such as “novice” and “expert,” it will be appreciated that a variety of different types of competency level indications may be used in other embodiments. For example, skill competency levels, in other embodiments, may be indicated by a number, a symbol, an icon, a color, and/or some other visual indicator.

The user may select upload option 522 in user interface 500 in order to upload a resume file, such as a text document, to the skill management system 110. The user may select option 524 in order to indicate that the skill management system 110 should automatically determine additional skills to associate with the resume based on the text of the uploaded resume document. For example, the skill management system 110 may determine one or more additional skills by implementing a method similar to illustrative method 600, described below. In some embodiments, the skill management system 110 may present the automatically identified skills to the user for verification prior to associating the additional skills with the user in user data store 124.

FIG. 6 is a flow diagram of an illustrative method 600 implemented by the skill generator module 112 for determining skill information from text data. The illustrative method begins at block 602, where the skill generator module 112 receives the text data to be parsed. The text data may be, for example, data entered by a user into a text field or information retrieved from a text file, such as an uploaded resume. Once the text data has been received from a user or retrieved from a data store, the illustrative method 600 proceeds to block 604, where the skill generator module 112 separates the received text data into one or more discrete portions. For example, the skill generator module 112 may identify natural breakpoints in the text, such as sentences, list entries (such as in the case of a bullet point list in a resume), paragraphs or other sections. The skill generator module 112 may then break the text into discrete portions based on the identified breakpoints in order to process each discrete portion separately. The discrete portions may be, depending on the embodiment, sentences, sentence fragments, phrases, paragraphs and/or other text blocks. In other embodiments, the skill generator module 112 may not separate the text, but instead analyze the received text as a single portion for purposes of determining skill information.

At block 606, the skill generator module 112 analyzes the current portion of text (in this case, the first identified portion of text) to identify language indicative of a skill. In certain embodiments, the skill generator module 112 may apply one or more rule sets based at least in part on grammatical rules, words or phrases known to be associated with skills, word proximity analysis of competency-related terms and skill-related terms, and/or other criteria. As one example, the skill generator module 112 may retrieve lists of known skill-related verbs and nouns (e.g., objects of the listed verbs) from the skill data store 122 and determine whether any known verb, noun and/or verb-noun combination appears within the current portion of text. In other embodiments, the skill generator module 112 may retrieve full phrases or other skill entries from the skill data store that the skill generator module 112 may then search for in the current portion of text. In some embodiments, the skill generator module 112 may be configured to identify different grammatical variations of known skill-related verbs. For example, the skill generator module 112 may recognize the skill “repairing computers” in text that reads “repaired computers,” “computer repair,” and/or similar phrases, which may include the words “repair” and “computer” being separated by other words. In some embodiments, the skill generator module 112 may additionally retrieve synonym information from the skill data store and/or another data source, and may use the retrieved synonym information to identify words in the current portion of text that are synonymous with known skill verbs and/or nouns.

At block 608, the skill generator module 112 identifies a word or phrase in the current portion of text that is indicative of a competency or proficiency level. For example, the skill generator module 112 may retrieve a list of words or phrases from the skill data store 122 that have been associated with a competency level based on predefined mapping information. As one example, a beginner or novice competency level may be associated with a number of different phrases or words that the skill generator module 112 may search for in the current portion of text. Examples of words or phrases indicative of a beginner competency level may include, as a few examples, “intern,” “just started,” “amateur,” “began learning,” “entry level,” “trainee,” etc. In some embodiments, the skill generator module 112 may determine whether any identified words or phrases indicative of competency level are grammatically associated with, and/or within a given proximity of, the skill language identified at block 606. While not sufficient to determine a competency level, an indication of the number of years of experience that an individual has had a given skill and/or has been in a particular job in which the user utilizes the given skill may additionally be considered by the skill generator module 112 as one factor in determining a competency or proficiency level. The skill generator module 112 may store any identified years of experience or length of time mentioned in the current portion of text as an additional data entry in association with the determined competency level.

Next, at block 610, the skill generator module 112 determines and stores a skill entry for the current portion of text based at least in part on the skill language identified at block 606 and any competency level language identified at block 608. In some embodiments, the generated skill entry may include a verb, a noun (e.g., an object of the verb), and a competency level, which may each be stored as separate related entries or as a single entry. As previously discussed herein, in other embodiments, the generated skill entry may be a single noun or phrase that is associated with a competency level, or may be a single phrase that incorporates competency or proficiency information. The generated skill entry may be stored by the skill generator module 112 in the user data store 124 in association with an account of the user and/or with a specific resume from which the text was parsed. After storing the skill entry, the illustrative method proceeds to block 612, where the skill generator module 112 determines whether there are additional portions of the text to analyze. If there is additional text to analyze, the skill generator module 112 advances to the next portion of text, at block 614, then returns to block 606 to analyze the next text portion for skill information. If there are no additional portions of text to analyze, the illustrative method 600 ends at block 616.

FIG. 7 is a flow diagram of an illustrative method 700 implemented by the skill search module 114 for matching one or more candidates to search criteria that includes skill information. While illustrative method 700 is described below as a method of searching for candidates that match received skill criteria, it will be appreciated that similar methods may be implemented by the skill generator module 112 to search for job listings that match received skill criteria. The illustrative method 700 begins at block 702, where the skill generator module 112 receives at least one mandatory skill, a skill category and any optional skills desired of a candidate. In some embodiments, each skill may be associated with a minimum competency level required of candidates. The information may be received, for example, from a recruiter or employer that wishes to locate individuals with certain skills. In some embodiments, the received information may include a primary mandatory skill and a secondary mandatory skill, which may each be skills that a candidate must possess in order to be considered a match for the search (or a match for the job opening associated with the search). A sample user interface for receiving a mandatory skill, skill category and optional skills is discussed in more detail below with reference to FIG. 8. In other embodiments, the skill information may be retrieved from a previously submitted search, may be retrieved from a stored job listing, or may be at least partially determined automatically from text information (as discussed above with reference to FIG. 6).

At block 704, the skill generator module 112 retrieves profile information and/or resume records for a number of individuals from a data store, such as user data store 124. For example, in some embodiments, each job seeker that has an account with the skill generator module 112 may have previously uploaded and/or submitted information associated with one or more resumes, where multiple resumes associated with the same individual may be tailored to different job functions, different primary skills, different secondary skills, and/or other information that varies between the resumes. In some embodiments, the skill generator module 112 may additionally or alternatively maintain a profile for each user that includes skill information, skill category information, job history, and/or other information, which may be stored separately from the one or more resumes associated with the given user. In some embodiments, the skill generator module 112 may retrieve, at block 704, each resume associated with an individual to determine whether any of the resumes match the submitted search criteria. In other embodiments, the skill generator module 112 may only consider a primary resume for each user, or may only consider skill information listed in a user's profile information.

At block 706, the skill generator module 112 determines a match score for at least a subset of the individuals for whom records were retrieved. The match score may be determined based at least in part by comparing the received mandatory skill(s), skill category and/or optional skills with each retrieved record (e.g., each resume and/or each user profile). In some embodiments, a match score may only be determined for records that match at least the required mandatory skill(s) indicated at block 702. For example, if a primary mandatory skill and secondary mandatory skill were indicated as required of candidates, the skill generator module 112 may first filter out all resumes in which the primary mandatory skill associated with the resume does not match the primary mandatory skill received at block 702, as well as resumes in which the secondary mandatory skill associated with the resume does not match the secondary mandatory skill received at block 702. In other embodiments, the skill generator module 112 may treat only the primary mandatory skill as required, but give greater weight to a match of a secondary mandatory skill than to a match of an optional skill. In matching skills, the skill generator module 112 may consider any minimum competency levels associated with the skill(s) that were requested in the search criteria (e.g., the search criteria may indicate that the primary skill requires at least an intermediate competency level). In some embodiments, two skills may be considered a match even if they are not identical. For example, the skill generator module 112 may consult a table of synonyms, grammatical variations, and/or related skills when determining whether a given skill entry in a resume or profile matches a skill provided in the search criteria.

In some embodiments, the match score for a given record may be based in part on various weights applied to each element of the provided search criteria. According to one embodiment, the order of relative weight, from highest to lowest, may be: matching the primary mandatory skill, matching the secondary mandatory skill, matching the skill category, and matching one or more optional skills. In some embodiments, each of the optional skills provided in the search criteria may be ordered, such that when calculating the match score for a given record, optional skills listed higher in the provided criteria are given greater weight when matched in the record than when lower ranked optional skills are matched. In other embodiments, the match score for a given record may be based in part on the number of optional skills matched or on a percentage of the optional skills matched in the given record.

At block 708, the skill generator module 112 ranks the potential candidates based at least in part on the determined match scores. For example, the records (which may include profiles and/or resumes) may be sorted in descending order based on the determined match score for each record. In some embodiments, if multiple records were analyzed for a given candidate, such as two resumes associated with the same individual, the skill generator module 112 may remove the lower ranking records from the results. The skill generator module 112 may additionally apply any other search filters (such as location or industry, discussed further below) to the resulting list of search results. At block 710, the resulting list of the top ranked candidate(s), if any, who meet the minimum mandatory criteria may be provided to the searcher.

In some embodiments, the skill generator module 112 may, at block 712, optionally generate an automatic connection request between the searcher (such as a recruiter) and one or more of the top ranking candidates. For example, the recruiter may indicate at the time of searching that he would like to establish a connection with a certain number of top candidates within a social networking service, business networking service and/or employment networking service provided by the operator of the skill management system 110 or provided by a third-party operator. Automatic connection requests are described further below. The illustrative method 700 then ends at block 714.

FIG. 8 is an illustrative user interface 800 generated by the skill management system 110 that enables a user to enter candidate search criteria to submit a search for candidates matching the provided search criteria. As illustrated, the illustrative user interface 800 may be presented to a recruiter or employer that wishes to locate candidates for a job opening and/or to establish a networking connection. The illustrative user interface 800 may be generated by the skill management system 110 for display on a user computing device, such as one of user computing devices 104. The user interface 800 includes a selection of different search types 802, including a candidate skill search, a candidate profile search and a candidate resume search. The user interface also includes search refinement options 830, from which the user may select filter or refinement criteria to narrow the set of potential candidates that will be considered in the search. As illustrated, the refinement or filter options include location, industry, business area, skill category, skills, job title, profile updated date, educational level, educational major or degree, and compensation amount. It will be appreciated that a number of search refinements not illustrated may be presented as refinement options in other embodiments.

The illustrative interface 800 includes a business area option 804, which may be selected by the user to indicate a business area associated with the search. As illustrated, the user has selected the business area as “IT: Software Development.” In other embodiments, a user may be able to select more than one business area associated with the search. The user interface 800 also includes a selectable option 806 for identifying a skill category for the search, which has been selected as “Web Mastering” by the user. The user interface 800 further includes primary skill criteria 810 and secondary skill criteria 820 for the search. While the skill criteria 810 and 820 are illustrated in user interface 800 as pull-down options and text fields for manual entry, in other embodiments, the primary and secondary skill information may be determined by the skill management system 110 from free-form text or other input methods, as discussed above.

The user interface 800 further includes an automatic connection option 822, which the user may select or deselect. The automatic connection options includes an option 824 to select the number of top candidates to whom the searching user would like the skill management system 110 to automatically send a connection request. As discussed above, a connection request may be an invitation to a given candidate that the candidate may accept in order to establish a connection with the recruiter or other searching user on a social networking service, employment networking service, business networking service or other service. In some embodiments, if a candidate accepts an invitation to establish a connection, the skill management system 110 may automatically generate an interview request for an interview to be conducted between the recruiter and the given candidate. The interview may be, for example, a phone interview, video interview, in-person interview, or other form of interview. In some embodiments, the skill management system 110 may be configured to ensure that the recruiter is not able to view certain information associated with the candidate prior to the interview, such as a photograph, in order to comply with any legal requirements. When the recruiter is ready to submit the search criteria to the skill management system 110, the user may select the submit option 832 in order to request search results matching the provided search criteria.

FIG. 9 is an illustrative user interface 900 generated by the skill management system 110 that presents candidate matches for skill-based search criteria entered by a user. The illustrative user interface 900 may be presented, for example, in response to a user selecting the submit option 832 discussed above with reference to FIG. 8. The user interface 900 includes information identifying the top candidate matches 902-905 for the user's submitted search criteria. The candidates 902-905 may have been determined by the skill management system 110, for example, by implementing a method similar to illustrative method 700 described above. As illustrated by text 914, the skill management system 110 may have automatically sent connection invitations to candidate matches 902, 903 and 904 based on these candidates being the top three matches. If the user wishes to establish a connection with another candidate, such as candidate 905, the user may select option 916 in order to request that the skill management system 110 send an invitation to candidate 905 to establish a connection with the searching user. If the searching user wishes to view more information regarding candidate 902, for example, the user may select option 910 to view the candidate's profile and skill information or option 912 to view the candidate's resume.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method for identifying one or more individuals matching a skill-based search request, the computer-implemented method comprising:
as implemented by one or more computing devices configured with specific executable instructions:
electronically receiving from a computing device, in association with a search request submitted by a user, a plurality of search criteria, the search criteria including a primary mandatory skill desired of an individual, a minimum competency level associated with the primary mandatory skill, one or more optional skills, and a skill category, wherein the skill category is selected by the user from a predefined list;
retrieving, from an electronic data store, a plurality of profiles, wherein each profile is associated with a single individual and includes information identifying at least a primary skill, a competency level of the individual with respect to the primary skill, a skill category and one or more additional skills associated with the individual;
determining that a subset of the retrieved profiles are eligible matches for the search request, wherein determining that a profile is an eligible match comprises:
determining that the primary mandatory skill included in the search criteria matches the primary skill included in the profile;
determining that the competency level associated with the primary skill included in the profile complies with the minimum competency level included in the search criteria; and
determining that the skill category included in the search criteria matches the skill category included in the profile;
sorting the eligible matches based at least in part on a comparison of the one or more optional skills included in the search criteria with the one or more additional skills included in each profile of the eligible matches; and
presenting information identifying one or more most qualified individuals for the search request, wherein the most qualified individuals are associated with one or more profiles appearing highest in the sorted eligible matches.

2. The computer-implemented method of claim 1, further comprising determining a match score for each eligible match, wherein the eligible matches are sorted based at least in part on the match scores.

3. The computer-implemented method of claim 2, wherein the match score for each eligible match is determined based at least in part by applying weights to each of the plurality of search criteria based at least in part on one or more types of search criteria provided.

4. The computer-implemented method of claim 1, further comprising automatically sending an invitation to one or more of the most qualified individuals to establish an electronic connection with the user that submitted the search request.

5. The computer-implemented method of claim 1, wherein the primary mandatory skill comprises a verb and a noun.

6. The computer-implemented method of claim 1, wherein the primary mandatory skill comprises at least one of (a) a verb and an adverb, or (b) a verb and an object of the verb.

7. The computer-implemented method of claim 5, wherein the verb is selected by the user from a predefined list and the noun is entered by the user as freeform text.

8. The computer-implemented method of claim 1, wherein the primary mandatory skill is determined based at least in part by parsing text data to identify a verb and a corresponding object.

9. The computer-implemented method of claim 1, wherein the search criteria further includes a secondary mandatory skill and a competency level associated with the secondary mandatory skill, wherein the primary mandatory skill is designated as being of greater importance than the secondary mandatory skill.

10. The computer-implemented method of claim 1, wherein determining that the primary mandatory skill included in the search criteria matches the primary skill included in the profile includes determining whether at least a portion of the primary mandatory skill is synonymous with at least a portion of the primary skill included in the profile.

11. The computer-implemented method of claim 1, wherein the minimum competency level is only selectable by the user after the user selects the primary mandatory skill, wherein the minimum competency level indicates a desired competency level for an individual to possess with respect to the primary mandatory skill.

12. The computer-implemented method of claim 1, wherein an individual is associated with two or more profiles that each include a different primary skill.

13. A system for identifying one or more individuals matching a search request, the system comprising:
a data store that stores a plurality of data records, wherein each record is associated with an individual and includes information identifying at least a primary skill, a competency level of the individual with respect to the primary skill, a skill category and one or more additional skills associated with the individual; and
a computing system, comprising one or more physical processors, in communication with the data store and that is configured to:
electronically receive from a computing device, in association with a search request submitted by a user, a plurality of search criteria, the search criteria including a primary mandatory skill desired of an individual and a desired competency level associated with the primary mandatory skill;
retrieve at least a subset of the plurality of records from the data store;
determine a match score for each of the retrieved records, wherein the match score for a record is determined based at least in part by:
comparing the primary mandatory skill included in the search criteria with the primary skill included in the record; and
comparing the competency level associated with the primary skill included in the record with the competency level included in the search criteria; and
present information identifying one or more qualified individuals for the search request, wherein the one or more qualified individuals are identified based at least in part on the match scores determined for one or more records associated with the one or more qualified individuals.

14. The system of claim 13, wherein each of the one or more records comprises at least one of a profile or a resume.

15. The system of claim 13, wherein the primary mandatory skill comprises a verb and a noun.

16. The system of claim 13, wherein the computing system is further configured to automatically send an invitation to one or more of the qualified individuals to establish an electronic connection with the user that submitted the search request.

17. The system of claim 13, wherein the primary mandatory skill is determined based at least in part by parsing text data.

18. The system of claim 13, wherein the primary mandatory skill is selected by the user from a user interface element that lists a plurality of skills, wherein the listed skills are determined based at least in part on a plurality of skills previously entered by a plurality of other users.

19. The system of claim 13, wherein comparing the primary mandatory skill included in the search criteria with the primary skill included in the record comprises determining whether at least a portion of the primary mandatory skill is synonymous with at least a portion of the primary skill included in the record.

20. A computer-implemented method for generating a skill entry, the computer-implemented method comprising:
as implemented by one or more computing devices configured with specific executable instructions:
retrieving text data to be parsed, wherein the text data is associated with at least one of a resume or a job listing;
separating the retrieved text data into one or more portions of text;
analyzing each of the one or more portions of text to determine skill entry information, where analyzing each text portion comprises:
identifying, in the text portion, language indicative of a skill; and
identifying, in the text portion, at least one word that is indicative of a competency level associated with the skill;
generating at least one skill entry based at least in part on the determined skill entry information, wherein each skill entry comprises a skill and a competency level; and
storing the at least one generated skill entry in an electronic data store in association with at least one of an individual or a company associated with the text data.

21. The computer-implemented method of claim 20, wherein the skill included in the generated at least one skill entry comprises a verb and an object.

22. The computer-implemented method of claim 20, wherein the one or more portions of text comprise at least one of a sentence, a phrase or a paragraph.

23. The computer-implemented method of claim 20, wherein the language indicative of a skill is identified based at least in part by applying one or more grammatical rules stored in a rule set.

24. The computer-implemented method of claim 20, wherein identifying language indicative of a skill includes identifying a verb and noun pairing in the text portion.

25. A non-transitory computer-readable medium having a computer-executable component for identifying one or more individuals matching a search request, the non-transitory computer-readable medium comprising:
a user interface component for:
presenting user interface elements for receiving skill entry information from a user, wherein the user interface elements comprise a first element for indicating a verb associated with a skill, a second element for indicating a noun associated with the skill, and a third element for selecting a competency level associated with the skill; and
receiving user-inputted skill entry information based at least in part on user interaction with the presented user interface elements; and
a search component for:
determining at least one stored record matching the user-inputted skill entry information, wherein the at least one stored record comprises information identifying one or more skills associated with at least one of an individual or a job listing.

26. The non-transitory computer-readable medium of claim 25, wherein the at least one stored record comprises information identifying a skill and an associated level of competency possessed by an individual.

27. The non-transitory computer-readable medium of claim 25, wherein the at least one stored record comprises information identifying a required skill and an associated minimum level of competency required for a job opening.

28. The non-transitory computer-readable medium of claim 25, wherein the user-inputted skill entry is further associated with a skill category and a business area selected by the user.

29. The non-transitory computer-readable medium of claim 25, wherein the user interface component is further for presenting information associated with the at least one matching stored record, wherein the presented information identifies a job candidate or an available job.
